(19) United States
(12) Patent Application Publication
(10) Pub. No.: US 2010/0051421 A1
(43) Pub. Date: Mar. 4, 2010

(54) CONTINUOUS HAULAGE SYSTEM

(76) Inventor: Shaun Douglas Dickson, Middleburg (ZA)

Correspondence Address: LADAS & PARRY LLP, 26 WEST 61ST STREET, NEW YORK, NY, 10023, US

(21) Appl. No.: 12/374,156

(22) PCT Filed: Jul. 19, 2007
(86) PCT No.: PCT/IB2007/052881

§ 371 Date: Jun. 1, 2009

(30) Foreign Application Priority Data
Jul. 21, 2006 (ZA) 2006/06054

(51) Int. Cl. B65G 21/14

(52) U.S. Cl. 198/812

(57) ABSTRACT

Continuous haulage system (10) suitable for use in the mining industry, including an extendible conveyor belt (20) adapted to extend when a tensile force is exerted on the conveyor belt, and to retract when the tensile force is removed, the extendible conveyor belt being biased to the retracted condition; and an extendible cable (30) adapted to extend when a tensile force is exerted on the cable, and to retract when the tensile force is removed, the extendible cable being biased to the retracted condition. The extendible cable is located at least partially adjacent to the extendible conveyor belt, so as to provide support for the extendible conveyor belt when the conveyor belt is extended.

The invention relates to a novel continuous haulage system suitable for use in the mining industry, and more particularly, but not exclusively, to a continuous haulage system suitable for use in coalmines.

### BACKGROUND TO THE INVENTION

Various continuous mining systems are known, and are used for purposes of increasing the capacity and efficiency of mining operations, such as coal mines.

A continuous mining system usually includes a continuous mining machine that is operatively associated with an ore feeder breaker, which is again operatively associated with a conveyor belt system. The continuous mining machine generally comprises a mining machine having a cutter head with which ore is cut from an ore face during single or multiple passes, and then discharged form the machine onto some sort of haulage device, which may be a continuous or a batching system. The ore is then transported to the ore feeder breaker, where the ore is broken into smaller particles before it is conveyed from the mining area by way of the conveyor belts.

Many continuous mining systems operate with a batching system, whereby ore is conveyed from the continuous mining machine by way of shuttle cars that travel between the continuous mining machine and the ore feeder breaker. This configuration results in the operation of the continuous mining machine to be Interrupted in periods where the arrival of an empty shuttle car is awaited, thus resulting in obvious inefficiency.

Some continuous haulage systems are known where the continuous mining machine discharges ore directly on the ore feeder breaker, which is in turn connected to a continuous conveyor system. However, existing continuous haulage systems are bulky and expensive. Known systems are also limited in terms of the distance that the continuous conveyor system, and thus the continuous mining system as a whole, can be displaced.

### OBJECT OF THE INVENTION

It is accordingly an object of the invention to provide a continuous haulage system that will, at least partially, alleviate the abovementioned disadvantages.

It is a further object of the invention to provide a continuous haulage system that will be a useful alternative to existing continuous haulage systems.

### SUMMARY OF THE INVENTION

According to the invention there is provided a continuous haulage system, suitable for use in a continuous mining system, the continuous haulage system including:
an extendible conveyor belt adapted to extend when a tensile force is exerted on the conveyor belt, and to retract when the tensile force is removed, the extendible conveyor belt being biased to the retracted condition; and
an extendible cable adapted to extend when a tensile force is exerted on the cable, and to retract when the tensile force is removed, the extendible cable being biased to the retracted condition;
wherein the extendible cable is located at least partially adjacent the extendible conveyor belt, so as to provide support for the extendible conveyor belt when the conveyor belt is extended.

The continuous haulage system may include a cable storage device in the form of a cable reel adapted to allow the cable to unwind when a tensile force is exerted on the cable, and to rewind the cable when the tensile force is removed.

The cable storage device may be biased towards a winded condition by means of any one or a combination of mechanical, hydraulic or electric biasing means. Preferably the biasing means may be in the form of a constant tension winch, as is known in the art.

There is provided for the continuous haulage device to be located between a conveyor belt drive unit and an ore feeder breaker, the cable storage device being connected to the conveyor belt drive unit or alternatively to the ore feeder breaker. Alternatively, cable storage devices may be provided on both the conveyor belt drive unit and the ore feeder breaker.

There is provided for the conveyor belt and the cable to extend when the ore feeder breaker is displaced away from the conveyor belt drive unit.

The cable preferably is configured to be located to the side of and/or below the conveyor belt. Preferably an extendible cable is provided on each side of the conveyor belt.

The continuous haulage device may also include removable conveyor idlers that are attachable to the extended cable so as to support the conveyor belt. In use the removable conveyor idlers may be attached to the cable on the side of the cable being connected to the cable storage device as the cable unwinds from the cable storage device. An axis of the conveyor idler may be secured relative to the cable by way of any suitable securing means.

The continuous haulage device may further include removable supports for supporting the cable relative to a surface on which the continuous mining system is used. Each support may have a first end that is releasably connectable to the cable as it extends, and a second end that moveably abuts the surface on which the continuous mining system is used. The second end may terminate in a wheel formation or a skid formation.

Alternatively, the supports may extend from a roof of a passage in which the continuous mining system is used.

In use the removable supports and the conveyor idlers may be attached to the cable at the end of the cable that is connected to the cable storage device, as the cable unwinds from the cable storage device.

The continuous haulage system may include a loading cartridge, the cartridge being adapted automatically to attach the removable supports and removable conveyor idlers to the extendible cable as the belt and the cable are extended.

A plurality of supports and idlers may be housed within the loading cartridge.

According to a further aspect of the invention there is provided a continuous mining system, Including:
a continuous haulage device as described hereinbefore;
an ore feeder breaker; and
a conveyor belt drive unit;
the continuous haulage device being located between the ore feeder breaker and the conveyor belt drive unit.

The cable storage device of the continuous haulage system may be connected to the conveyor belt drive unit or alternatively to the ore feeder breaker. Alternatively, cable storage devices may be provided on both the conveyor belt drive unit and the ore feeder breaker.

The continuous mining system may also include a continuous mining machine.

Preferably, the ore feeder breaker is displaced by the continuous mining machine to which it is connected, and alternatively is displaced by its own driving means.

The ore feeder breaker may be connected to the continuous mining machine by way of an at least partially pivotable telescopic conveyor so as to allow the continuous mining machine to be at least partially displaceable relative to the ore feeder breaker.

The conveyor belt drive unit includes a belt take up mechanism comprising at least two rollers adapted to be displaceable relative to one another, the rollers being biased away from one another. In a preferred embodiment at least one roller is a stationary roller having a stationary rotation axis, and at least one roller is a displaceable roller having a rotation axis that is displaceable away form the stationary roller, the displaceable roller being biased away from the stationary roller.

The bias exerted on the displaceable roller is sufficient to prevent displacement of the roller when a tensile force exerted on the conveyor belt is less than the predetermined force. There is provided for the displaceable roller to be displaced against the bias towards the stationary roller when the tensile force exerted on the conveyor belt exceeds the predetermined force, in so doing extending the effective length of the conveyor belt by displacing the two rollers towards one another.

Any one or a combination of mechanical, hydraulic or electric biasing means may provide the bias. In one preferred embodiment the biasing means is in the form of a constant tension winch.

### BRIEF DESCRIPTIONS OF THE DRAWINGS

One preferred embodiment of the invention is described by way of a non-limiting example, and with reference to the accompanying drawings in which;

FIG. 1 is a perspective view of the continuous mining system incorporating the continuous haulage system in accordance with the invention;

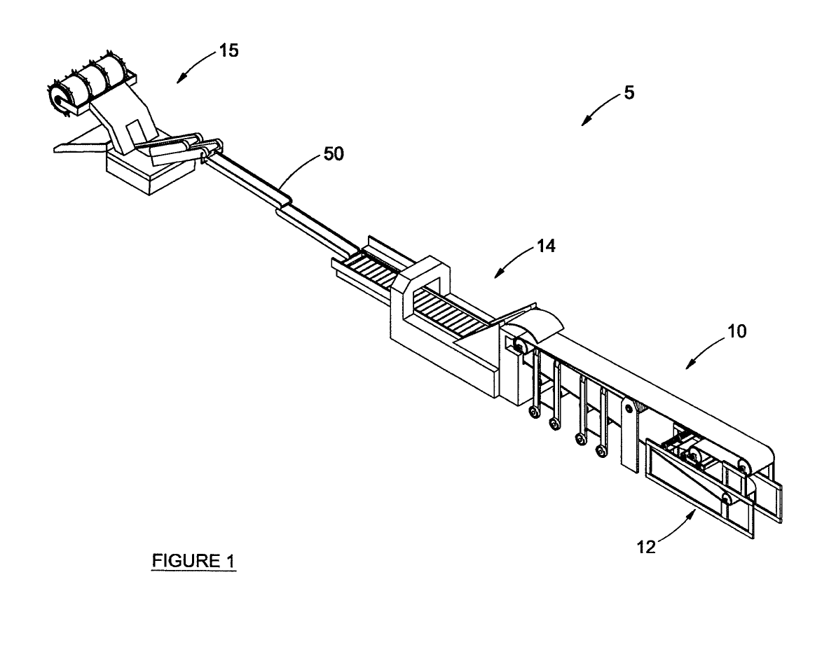

FIG. 2 is a perspective view of the continuous haulage system in accordance with the invention;

FIG. 3 is a perspective view of the continuous haulage system in a first position; and

FIG. 4 is a perspective view of the continuous haulage system in a second position.

### DETAILED DESCRIPTION OF THE INVENTION

Referring to the drawings, in which like numerals indicate like features, a continuous mining system is indicated by reference numeral 5, and includes a continuous haulage system 10, a conveyor belt drive unit 12, an ore feeder breaker 14 and a continuous mining machine 15.

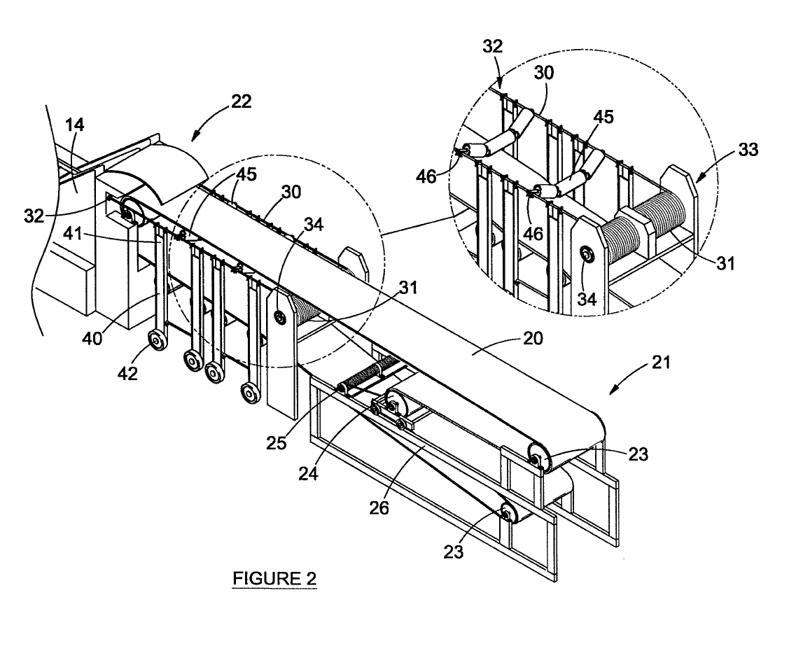

The continuous haulage system 10, as seen in FIG. 2, includes an extendible conveyor belt 20 adapted to extend when a tensile force exerted on the conveyor belt 20 exceeds a predetermined force, and to retract when a tensile force exerted on the conveyor belt is less than the predetermined tensile force. The continuous haulage system 10 also includes an extendible cable 30 adapted to extend when a tensile force exerted on the cable exceeds the predetermined force, and to retract when a predetermined tensile force exerted on the cable is less than the predetermined tensile force. Both the cable 30 and the conveyor belt 20 are biased towards retracted conditions. The extendible cable 30 is configured to be located at least partially adjacent the extendible conveyor belt when extended so as to provide support for the extendible conveyor belt 20.

The extendible conveyor belt 20 has a first end 21 and a second end 22. The first end 21 is connected to the conveyor belt drive unit 12, and the second end is connected to the ore feeder breaker 14. The conveyor belt drive unit is configured to allow the extension and retraction of the conveyor belt 20 if and when required. This is facilitated by a roller configuration wherein at least one stationary roller 23 and one displaceable roller 24 are provided. It will be appreciated that more rollers may be provided, depending on the amount of extension required. In this particular example the displaceable roller is mounted on a track 26, define by part of the frame of the conveyor belt drive unit 12, and the displaceable roller 24 is displaceable to and from the stationary roller 23 with limited friction.

The displaceable roller 24 is biased against being displaced towards the stationary roller 23 by way of biasing means in the form of a constant tension winch 25. The constant tension winch 25 allows displacement of the displaceable roller 24 when the tensile force exerted on the conveyor belt 20, and thus the force exerted on the roller 24 and transmitted to the winch 25, exceeds a certain predetermined set point. Likewise, the winch 25 will displace the displaceable roller 24 away from the stationary roller 23 when the tensile force reduces below the predetermined set point. The tensile force is induced by the displacement of the continuous mining machine 15 and the ore feeder breaker 14, as is discussed in more detail below.

The extendible cable 30 also includes a first end 31 and a second end 32. At least one of the ends of the extendible cable 30 will be connected to a cable storage device 33, but many configurations are foreseen. For instance, the cable storage device 33 may be secured to the conveyor belt drive unit, and the free end of the cable to the ore feeder breaker 14. Alternatively, the cable storage device 33 may be secured to the ore feeder breaker 14, with the free end of the cable connected to the conveyor belt drive unit 12. In a further embodiment cable storage devices 33 may be secured to both the ore feeder breaker 14 and the conveyor belt drive unit 12, with the cable 30 extending therebetween. In the particular embodiment shown in the figures the cable storage device 33 is secured to the conveyor belt drive unit 12 and the second or free end 32 of the cable is secured to the ore feeder breaker. One cable is provided on each side of the conveyor belt 20.

The cable storage device 33 includes a reel 34 onto which the cable 30 is wound. The reel is biased from being unwound, and is preferable in the form of a constant tension winch, similar to that used in the conveyor belt drive unit 12. The reel 34 is adapted to allow the cable to unwind when a tensile force exerted on the cable exceeds a predetermined force, and to rewind the cable when the tensile force exerted on the cable is less than the predetermined force. The predetermined force is similar to that used in the conveyor belt drive unit 12, and is also caused by the same displacement of the continuous mining machine 15 and the ore feeder breaker 14.

In use, both the conveyor belt 20 and the extendible cable 30 will extend when sufficient tension is applied thereto, due to the constant tension winches, 25 and 34, allowing displacement of respectively the displaceable roller 24 and the cable reel 34. When the continuous mining machine 15 and thus the ore feeder breaker 14 are displaced away from the conveyor belt drive unit (which remains stationary) the conveyor belt 20 will extend to take up the increasing distance. At this stage it is required that additional support be provided for preventing sagging of the conveyor belt 20. For this reason the extendible cable 30 is located adjacent the conveyor belt, and is configured to provide support as explained below.

Removable supports 40 are firstly provided to support the cable 30, and indirectly the conveyor belt 20. The removable supports 40 are connected to the cable 30 when the cable is extended, and can likewise be removed when the cable 30 is retracted. It will be appreciated that the supports 40 may take many forms. In this particular example the removable supports 40 include first ends 41 that are located adjacent the conveyor belt 20, and second ends 42 that abut the working surface in a moveable manner. In this example the second ends terminate in rollers or wheels, but it will be appreciated that skid formation or the like will also suffice. The removable supports 40 provide the required structural rigidity to the extended cables 30, and allow the cable to carry the downward force required to support the conveyor belt 20 when conveying ore.

Conveyor idler rollers 45, of well-known type and configuration, are mounted on the cables, and opposite ends of shafts of the conveyor idler rollers 45 rest on opposing cables 30 adjacent opposing edges of the conveyor belt 30. The conveyor idler rollers 45 are secured to the cables 30 by way of securing means 46. The securing means may be any of a number of known types of securing means. The rollers 45 and supports 40 may be installed manually, as is implied in the configuration shown in the figures. However, there is also provided for the rollers 45 and supports 40 to be automatically installed by way of a loading cartridge. The loading cartridge (not shown) may be located at the end of the cable where the cable storage device 33 is located, and holds a plurality of rollers 45 and supports 40 that are automatically attached to the cable as the cable is extended.

The continuous mining machine 15 and the ore feeder breaker 14 can be any one of many types of known devices. The continuous mining machine 15 is connected to the ore feeder beaker 14 by way of an at least partially telescopic conveyor 50, which also includes a pivotable section allowing relative angular displacement of the continuous mining machine 15 relative to the ore feeder breaker 14.

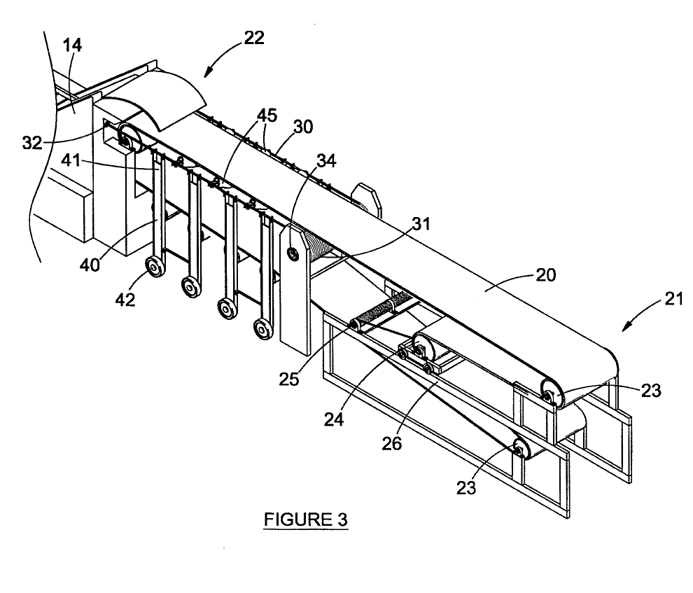

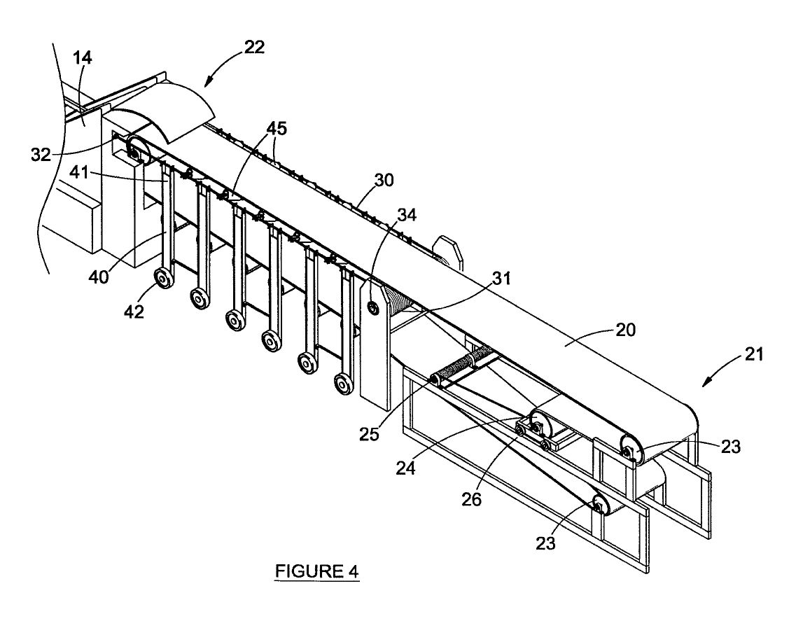

In use, the continuous mining machine 15 removes ore from a face of an ore body to be mined. As the continuous mining machine 15 removes the ore, the ore is conveyed via the telescopic conveyor 50 to the ore feeder breaker 14, where the ore is broke into smaller particles. From there the ore is removed via the extendible conveyor belt 20. As the ore body is mined, the continuous mining machine 15 is displaced away from the original starting position. The ore feeder breaker 14 is similarly displaced, thus imparting a tensile force on the extendible conveyor belt 20 as well as the extendible cable 30. When the force is sufficient to overcome the predetermined set point on the biasing devices, in the form of constant tension winches 25 and 34, the conveyor belt 20 and the cable 30 extend, as is illustrated in FIGS. 3 and 4, to compensate for the displacement of the ore feeder breaker 14 and the continuous mining machine 15. The displacement of the displaceable roller 24 relative to the stationary rollers 23 can be clearly seen in the sequence depicted in FIGS. 2 to 4.

As the cables 30 extend, additional supports 40 and conveyor idler rollers 45 are manually or automatically installed to provide added support to the extended conveyor belt 20. When the conveyor belt has reached a maximum length, a further conveyor belt extension, as is known in the art, may be installed to increase the length of the extendible conveyor belt 20. When the continuous mining machine 15, and thus the ore feeder breaker 14, is displaced towards the conveyor belt drive unit 12, the above process is reversed.

In the above system the use of auxiliary vehicles for conveying ore form the continuous mining machine 15 to the ore feeder breaker 14 is negated, as removal of ore is now a continuous process due to the introduction of an extendible conveyor belt that is supported by an extendible cable. This will lead to obvious increase in capacity.

It will be appreciated that the above is only one embodiment of the invention, and that there may be many variations without departing from the spirit and/or the scope of the invention. For example, the exact configuration of the removable support members, and the conveyor idler rollers are not essential, provided that the cable is in some way adapted to support the conveyor belt as it extends. The conveyor belt and extendible cable may also not be directly connected to the feeder breaker, but may also be connected to a tail end, which may in turn be connected to the ore feeder breaker.

1. A continuous haulage system, suitable for use in a continuous mining system, the continuous haulage system including:
an extendible conveyor belt adapted to extend when a tensile force is exerted on the conveyor belt, and to retract when the tensile force is removed, the extendible conveyor belt being biased to the retracted condition and being located at least partially adjacent the extendible conveyor belt, so as to aid in providing support for the extendible conveyor belt when the conveyor belt is extended;
an extendible cable adapted to extend when a tensile force is exerted on the cable, and to retract when the tensile force is removed, the extendible cable being biased to the retracted condition;
at least one removable support for supporting the cable relative to a surface on which the continuous mining system is used, and having a first end that is releasably connected to the cable as the cable extends and a second end that displaceably abuts the surface on which the continuous mining system is used; and
a loading cartridge being adapted to automatically attach the removable supports to the extendible cable as the belt and the cable are extended.

2. The continuous haulage system of claim 1, wherein the continuous haulage system includes a cable storage device in the form of a cable reel adapted to allow the cable to unwind when a tensile force is exerted on the cable, and to rewind the cable when the tensile force is removed.

3. The continuous haulage system of claim 2, wherein the cable storage device is biased towards a winded condition by means of any one of the biasing means selected from the group including mechanical, hydraulic or electric biasing means or a combination thereof.

4. The continuous haulage system of claim 3, wherein the biasing means is in the form of a constant tension winch.

5. The continuous haulage system of claim 1, wherein the continuous haulage device is located between a conveyor belt drive unit and an ore feeder breaker, the cable storage device being connected to at least one or both of the conveyor belt drive unit and the ore feeder breaker.

6. The continuous haulage system of claim 5, wherein the conveyor belt and the cable is adapted to extend when the ore feeder breaker is displaced away from the conveyor belt drive unit.

7. The continuous haulage system of claim 1, wherein the cable is located operatively towards the side of the conveyor belt.

8. The continuous haulage system of claim 7, wherein an extendible cable is provided on each side of the conveyor belt.

9. The continuous haulage system of claim 8, wherein the continuous haulage device includes at least one removable conveyor idler that is attached to the extended cables so as to extend between the two cables in order to support the conveyor belt.

10. The continuous haulage system of claim 9, wherein a stationary axis of the conveyor idler is secured relative to the cable by way of any suitable securing means.

11. The continuous haulage system of claim 1, wherein the second end of the support terminates in a wheel formation or a skid formation.

12. The continuous haulage system of claim 1, wherein the support extends from a roof of a passage in which the continuous mining system is used.

13. The continuous haulage system of claim 9, wherein the loading cartridge is adapted to automatically attach the removable conveyor idlers to the extendible cable as the belt and the cable are extended.

14. A continuous mining system, including:
a continuous haulage device as claimed in claim 1,
an ore feeder breaker; and
a conveyor belt drive unit;
the continuous haulage device being located between the ore feeder breaker and the conveyor belt drive unit.

15. The continuous mining system of claim 14, wherein a cable storage device of the continuous haulage system is connected to the conveyor belt drive unit.

16. The continuous mining system of claim 14, wherein a cable storage device of the continuous haulage system is connected to the ore feeder breaker.

17. The continuous mining system of claim 14, wherein cable storage devices are connected to the conveyor belt drive unit and the ore feeder breaker.

18. The continuous mining system of claim 14, including a continuous mining machine.

19. The continuous mining system of claim 18, wherein the ore feeder breaker is displaced by the continuous mining machine to which it is connected.

20. The continuous mining system of claim 18, wherein the ore feeder breaker is connected to the continuous mining machine by way of an at least partially pivotable telescopic conveyor, so as to allow the continuous mining machine to be at least partially displaceable relative to the ore feeder breaker.

21. The continuous mining system of claim 14, wherein the conveyor belt drive unit includes a belt take up mechanism comprising at least two rollers adapted to be displaceable relative to one another, the rollers being biased away from one another.

22. The continuous mining system of claim 21, wherein at least one roller is a stationary roller having a stationary rotation axis, and at least one roller is a displaceable roller having a rotation axis that is displaceable away form the stationary roller, the displaceable roller being biased away from the stationary roller.

23. The continuous mining system of claim 22, wherein the bias is provided by a constant tension winch.
